(19) United States
(12) Patent Application Publication
(10) Pub. No.: US 2003/0091401 A1
(43) Pub. Date: May 15, 2003

(54) Thread cleaning tool

(76) Inventor: William J. Thompson, Newport Beach, CA (US)

Correspondence Address: Albin H. Gess, Price and Gess, Suite 250, 2100 S.E. Main Street, Irvine, CA, 92614-6238, US

(21) Appl. No.: 10/035,465

(22) Filed: Nov. 9, 2001

(51) Int. Cl. B23G 5/04

(52) U.S. Cl. 408/221; 470/185

(57) ABSTRACT

The versatility of the present invention is evident in the preferred embodiment that has a driver with a bore extending therethrough from one end, with a cap at the other end. The bore has stepped inner diameters, which preferably contain at least two threaded sections of different diameters. The threaded section with the largest diameter is next to an opening of the bore. Each threaded section thereafter is proximate to a non-threaded space of the same diameter. The capped end can accept a variety of attachments such as a handle, the chuck of a drill bit, or the driver of a ratchet or wrench.

### BACKGROUND OF THE INVENTION

1. Field of the Invention

The present invention relates to a hand tool and more particularly, pertains to a thread cleaning tool.

2. Description of the Prior Art

There are many situations in which the threads of bolts or threaded rods are susceptible to collecting particles of dirt or metal shavings or are damaged at their terminal end during manufacture, transport or during use. In these situations, the threaded object has reduced effectiveness and increases frustration in use. The prior art has contemplated different ways of removing various particles from the threads, as well as rethreading in order to effectively use the screw, bolt or rod. Typically, such devices have internal thread-cutting dies or teeth. Such devices are shown in U.S. Pat. Nos. 3,956,787, 4,346,491, 4,630,978, and 5,803,676.

These devices are typically used to reset or re-cut the threads. These tools are often cumbersome, or do not cater to several different sizes of threads in one tool and are not versatile in use. The present invention provides a single tool for cleaning different thread sizes that permits hand use, manually or by power tool, or wrench use.

### SUMMARY OF THE INVENTION

The versatility of the present invention is evident in the preferred embodiment that has a driver with a bore extending therethrough from one end and a cap at the other end. The bore has stepped inner diameters that preferably contain at least two threaded sections of different diameters. The threaded section with the largest diameter is next to an opening of the bore. Each threaded section thereafter is proximate to a non-threaded space of the same diameter. The second end is capped and can accept a variety of attachments such as a handle, the chuck of a drill bit, or the driver of a ratchet or wrench.

### BRIEF DESCRIPTION OF THE DRAWINGS

The objects and advantages of the invention will be readily appreciated as the same becomes better understood by reference to the following detailed description when considered in conjunction with the accompanying drawings in which like reference numerals designate like parts throughout the figures thereof and wherein:

FIG. 1 is a perspective view of a preferred embodiment of the invention;

FIG. 2 is a sectional view of FIG. 1;

FIG. 3 is a side sectional view of FIG. 1 without the handle;

FIG. 4 is a top plan view of the capped end of FIG. 1 showing an alternative preferred shape for the bit at that end;

FIG. 5 is a top plan view of the capped end of FIG. 1 showing a second alternative preferred shape for the bit at that end;

FIG. 6 is a cross section of a preferred embodiment of the invention showing an alternate driver attachment at the capped end;

FIG. 7 is a close-up side view of the second end of FIG. 6; and

FIG. 8 is a top plan view of an alternate aperture shape at the capped end.

### DETAILED DESCRIPTION OF THE PREFERRED EMBODIMENTS

Referring to FIG. 1, the thread cleaning tool 10 of the invention is preferably made of steel round rod stock. This material is durable enough to withstand the levels of torque that this tool will experience in application. The steel round rod stock is internally drilled and tapped as needed in order to create the multiple thread sizes. The threaded segments are then preferably heat-treated.

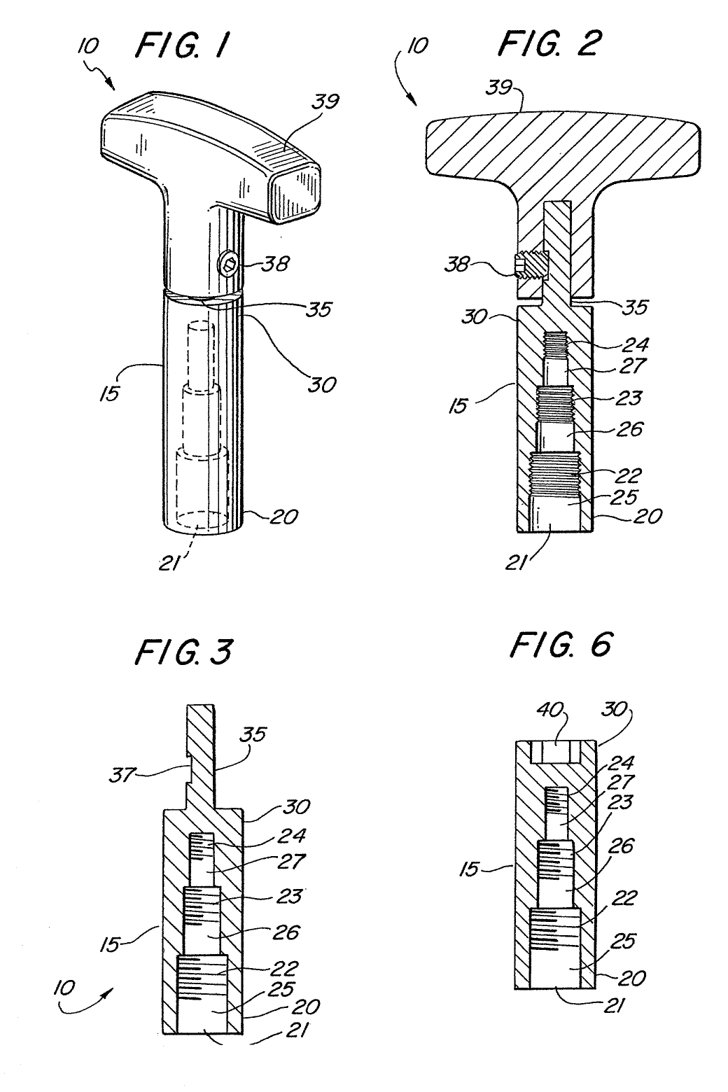

Referring to FIGS. 1 and 2 the tool 10 has a driver 15 with a first end 20 having a bore 21 therein and a second end 30 that is capped. The first end 20 has a tapered or stepped inner diameter that contains a plurality of threaded sections 22, 23, 24. The threaded sections 22, 23, 24 each has different diameter and thread sizes. The threaded section with the largest diameter 22 is next to the bore 21 in the driver 15. Each threaded section 22, 23, 24 is preferably next to a non-threaded space 25, 26, 27 of the same diameter, and preferably of the same length. These non-threaded spaces 25, 26, 27 serve as feed channels into their respective threaded sections. They compensate for burrs or disfigured threads before the threaded stud engages the threaded sections of the bore 21.

For example, if the threaded section with the largest diameter 22 is 0.500 inches in diameter and 0.375 inches in length then it will be proximate to a non-threaded section 25 that is 0.500 inches in diameter and 0.375 inches in length. Components of the present invention are preferably machined to a tolerance of +/−0.001 inches.

Each threaded section is adjacent to a threaded or non-threaded section of a decreased diameter. For example, threaded section 22 is flanked by non-threaded section 26 and threaded section 23 of a smaller diameter. It is preferable that the non-threaded section that is the same diameter as the adjacent threaded section is also the same length as the adjacent threaded section. The length of the non-threaded sections 25, 26, 27 allows for enough lead in space into the respective threaded sections 22, 23, 24 so that the threaded rod or bolt can properly engage the threaded sections 22, 23, 24 despite burrs or disfigured threads.

In this preferred embodiment each threaded section 22, 23, 24 is receptive to threads of a threaded stud of a particular size. For example, the threaded section 22 with the largest diameter can receive a bolt, screw, threaded stud or rod that has a diameter of ½-inch and is receptive to ½-inch thread. The next threaded section 23 will be receptive to a threaded stud of a smaller diameter such as ⅜-inch with a ⅜-inch thread. Threaded section 24 will again have a smaller diameter such as ¼-inch with a ¼-inch thread. As a result, this tool can service bolts, screws, studs, or threaded rods of several sizes, with no requirement to adjust the tool to change sizes.

The second end 30 of the driver 15 is capped and has a bit 35 extending therefrom. Preferably, the bit 35 is round with a flat spot 37 that is engaged by a set screw 38 in a handle 39 made to receive the bit 35. The bit may also be inserted into a drill chuck if powered rotation is desired.

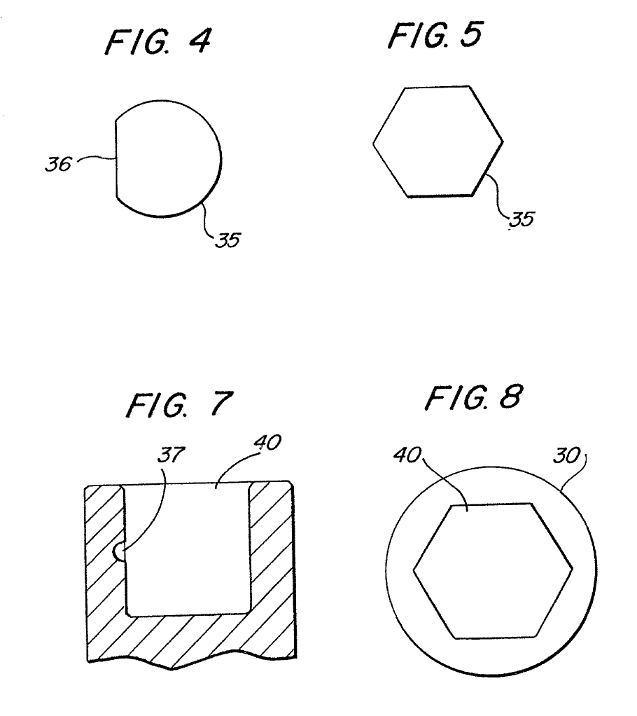

An alternate shape for the bit 35 is shown in FIG. 4 wherein the bit has a flat side 36. The bit 35 is adapted to accept a variety of attachments such as a handle 39, nut driver or a ratchet or the like. The set screw 38 locks into the notch 37 in order to prevent the handle from spinning on the bit 35. Preferably, the handle 39 is T-shaped and made of steel casting, or plastic, or any other material that will be durable enough to withstand the torque applied by the user. Using a handle attachment 39 is especially helpful when working in confined spaces that do not allow the room to use other tools such as a wrench or power tool.

The bit 35 may also be a polygon as shown in FIG. 5. This shape on the bit permits it to engage and be driven by a wrench or socket in situations where the handle 39 would not be convenient. The chuck of an electric drill will also readily engage the hexagonal bit 35.

An alternate embodiment for the driver 15 is shown in FIGS. 6, 7 and 8. The capped second end 30 of the driver has a recess 40 for accepting an insert. Preferably, the recess 40 has a square or hexagonal shape. If the recess 40 is square, a half-round recess 37 may be located in one of its sides to receive a catch ball bearing of a ratchet driver insert.

The recess 40 may be hexagonal as shown in FIG. 6. In this case, a hexagonal tool shaft may be used as the driver with a ratchet, electric drill or wrench supplying the torque. As above, a handle that is compatible with the recess 40 in the second end 30 could also be used.

In the preferred embodiment of the invention shown in FIGS. 1 and 2, the user will use the tool 10 by grasping the handle 39 and sliding the threaded object into the bore 21. Once the object is in the bore 21 the user can slide the object until it matches the diameter of one of the threaded sections 22, 23, or 24. At that point, the user can rotate the handle to rethread or clean the threaded rod. The handle 39 is rotated and the threads of the engaged section thread onto the threaded rod until the threads of the rod meet the proximate non-threaded section 25, 26, or 27. The threaded rod is then removed from the bore 21 by rotating the handle in a counter direction until the threads disengage. A wrench or socket can be used in the place of the handle 39. Additionally, a drill chuck can engage the bit 35 as desired. For the embodiment of FIG. 6, a bit of the appropriate shape, i.e., square or hexagonal is used to engage the mating recess 40 in the driver 15.

The present invention reduces the inconvenience of carrying a large variety of the appropriately sized cleaning and rethreading tools. The threaded sections available in various diameters allow for a multi-purpose yet compact thread cleaning tool. Furthermore, the tool 10 can be used in conjunction with a custom handle or commonly used driver, as desired, allowing for a wide range of uses and flexibility.

What is claimed is:

1. A stud thread tool, comprising:
a driver having a bore therethrough starting at a first end and ending at a second end which is capped, said bore being tapered along its length, with the largest diameter at the first end and the smallest diameter at the second end;
a plurality of threaded sections spaced along the length of the tapered bore; and
an attachment mechanism at the capped end adapted for attaching a torqueing device for turning said driver.

2. The tool of claim 1, wherein the tapered bore has at least three threaded sections of different diameters.

3. The tool of claim 1, wherein each threaded section is proximate to a non-threaded space of the same diameter.

4. The tool of claim 1, wherein the driver is made of steel.

5. The tool of claim 1, wherein the attachment mechanism is a bit extending from the capped second end.

6. The tool of claim 5, wherein the bit has a flat side to accept an attachment.

7. The tool of claim 5, wherein the bit is hexagonal.

8. The tool of claim 1, wherein the attachment mechanism has a notch that can engage a set screw.

9. The tool of claim 1, wherein the torqueing device is a handle.

10. The tool of claim 8, wherein the handle is T-shaped.

11. A stud cleaning device, comprising:
a driver having a bore therethrough starting at a first end and ending at a second end which is capped, said bore being tapered along its length, with the largest diameter at the first end and the smallest diameter at the second end;
a plurality of threaded sections with at least two sections of different diameters spaced along the length of the tapered bore;
wherein each threaded section is proximate to a non-threaded space of the same diameter and said threaded section has a decreased diameter from the non-threaded section thereto; and
an attachment mechanism at the capped end for attaching a torqueing device for turning said driver.

12. The device of claim 11, wherein the tapered bore has at least three threaded sections of different diameters.

13. The device of claim 11, wherein the attachment mechanism at the capped second end is a recess that can accept an insert.

14. The device of claim 13, wherein the recess is square.

15. The device of claim 14, wherein the square has a half round recess that receives a catch ball bearing in an insert.

16. The device of claim 13, wherein the recess is hexagonal.

17. The device of claim 13, wherein the recess accepts a handle attachment.

18. The device of claim 11, wherein the driver is made of steel.
